(19) United States
(12) Patent Application Publication
(10) Pub. No.: US 2015/0076220 A1
(43) Pub. Date: Mar. 19, 2015

(54) FABRIC LABELING SYSTEM AND METHOD

(71) Applicant: Soda Apparel, Inc., Seattle, WA (US)

(72) Inventor: Mark Nelson, Carnation, WA (US)

(21) Appl. No.: 14/485,292

(22) Filed: Sep. 12, 2014

Related U.S. Application Data
(60) Provisional application No. 61/877,621, filed on Sep. 13, 2013.

(51) Int. Cl. G06F 17/30; G09F 3/04; G09F 3/00

(52) U.S. Cl. CPC G06F 17/30879; G09F 3/00; G09F 3/04
USPC 235/375; 40/299.01; 40/638

(57) ABSTRACT

A fabric label that includes a base material applied to the fabric, and a labeling area on the base material organized into a dashboard arrangement having at least three sections that include a size section having indicia indicating a size of the fabric material, a matrix barcode section configured to store data related to at least one from among the fabric, reorder information, and a URI preferably in the form of a URL, and a care instruction section. A message section can also be included.

### BACKGROUND

1. Technical Field

The present disclosure pertains to product marking and, in one exemplary embodiment, to the application and use of indicia on fabric material.

2. Description of the Related Art

The marking of objects, particularly commercial goods, has a variety of purposes including, without limitation, identification, pricing, location tracking, usage and care instructions, compliance with government regulations, branding, authentication, and theft prevention. Such labeling often requires the use of multiple markings on the object, often at a variety of locations on the object. In addition, numerous means exist to associate the markings with the object including, without limitation, the direct application of ink on the object, using adhesive labels on the object, hang tags, and on product packaging. For example, in the garment industry, there are principally four types of labels—woven labels, leather labels, PVC/plastic labels, and embroidered labels.

When multiple markings are required on goods, sometimes by multiple parties, a product can become cluttered and crowded with labels and tags. Oftentimes users of garments do not like the feel of tags on their skin. Attempts to rip off a tag can sometimes damage the garment, such as tearing open a hem to which the tag is attached. Such tags add cost to the garment and increase the complexity of the manufacturing process.

Hence, there is a need for a labeling system that overcomes the foregoing disadvantages and provides a simple, consolidated, and easily readable label and associated system that utilizes modern electronic technology to enable ready identification of a garment, reordering of the garment, and tracking of the same by garment producers, distributors, and retailers.

### BRIEF SUMMARY

In one embodiment, the present disclosure is directed to a fabric label that includes a base material applied to the fabric; and a labeling area on the base material organized into at least three sections that comprise: a size section having indicia indicating a size of the fabric material; a matrix barcode section configured to store data related to at least one from among the fabric, reorder information, and a Uniform Resource Indicator (URI) such as a Uniform Resource Locator (URL); and a care instruction section.

In accordance with another aspect of the present disclosure, the labeling area further includes a message section. The message section can be configured to utilize indicia related to personalized content.

In accordance with yet another aspect of the present disclosure, a tag line section can be included in the labeling area, as well as a web address for a provider of the fabric to which the label is applied.

In accordance with a further aspect of the present disclosure, the labeling area comprises a dashboard arrangement of the size section, matrix barcode section, and care section. The dashboard arrangement is preferably oriented horizontally, although it may include a vertical arrangement of the sections or a combination of horizontal and vertical arrangements.

In accordance with another aspect of the present disclosure, a system is provided that includes a product; a tagless label applied to the product, the label comprising a labeling area organized into at least three sections that comprise: a size section having indicia indicating a size of the fabric material; a matrix barcode section configured to store data related to at least one from among the fabric, reorder information, and a URI or URL, and a care instruction section. Also included in the system are a remote computing system configured to be accessible via a worldwide network of computers using the URI in the matrix barcode section of the label, the remote computing system configured to enable at least one from among ordering of the product, information about the product, and information about the provider of the product; and a reader configured to read the matrix barcode in the matrix barcode section and to communicate with the remote computing system via the worldwide network of computers.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 illustrates a label applied to a fabric product in accordance with the present disclosure;

FIG. 2 illustrates a system utilizing the label of the present disclosure; and

FIG. 3 illustrates an implementation of the system of FIG. 2 using a reader, such as a mobile phone, to scan the matrix barcode and communicate with a computing system.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures or components or both associated with fabric products, computing systems and communication over the internet, and the printing and scanning of matrix barcodes, including QR codes have not been shown or described in order to avoid unnecessarily obscuring descriptions of the embodiments.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

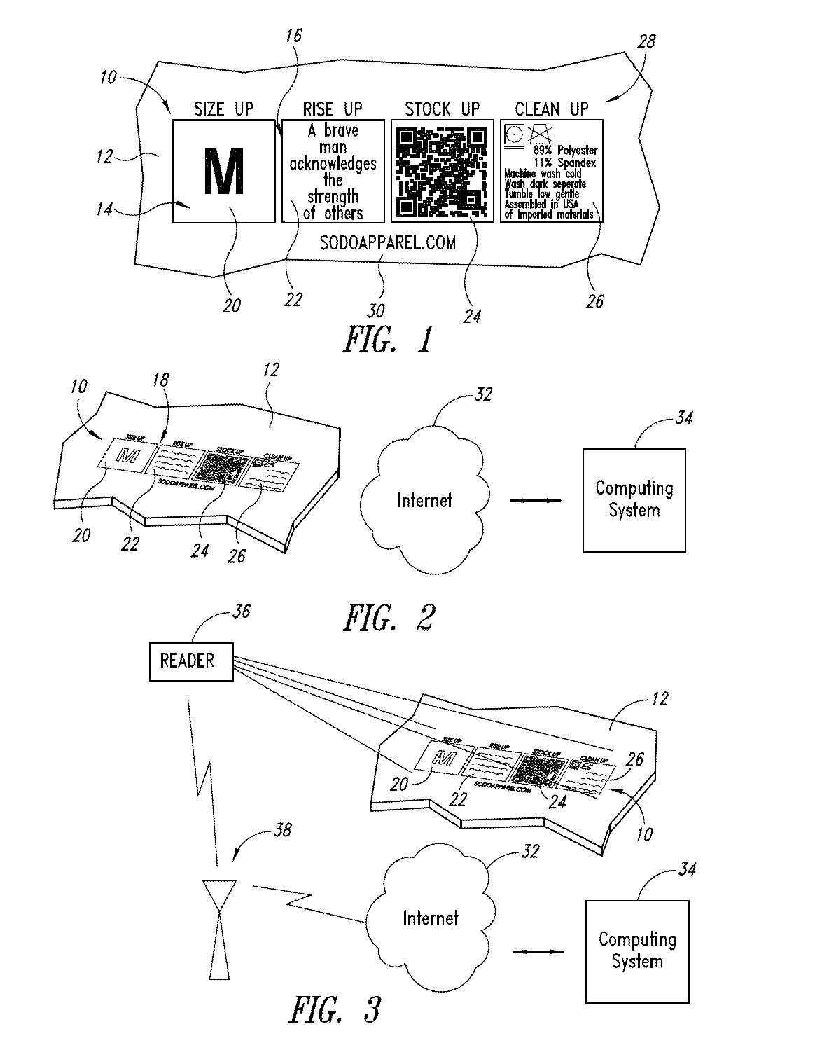

Referring initially to FIG. 1, shown therein is a tagless label 10 formed in accordance with the present disclosure as applied to a fabric material 12. The fabric material 12 can be 100% fabric or a fabric component of an object. For example, the fabric material can be an article of clothing such as a shirt, pants, skirt, coat, hat, gloves, footwear, underwear, outerwear, and other known apparel. This can also include accessories, such as a scarf. Other fabric products include, without limitation, sheets, bedding, linens, curtains, and furniture. The label of the present disclosure can also be applied to other goods or articles that are non-fabric in nature.

The label 10 is applied to the fabric material 12 in a manner that is tagless, i.e., without using another piece of fabric, paper or plastic. Preferably, the label 10 is formed of a heat-reactive base material that is applied to the fabric material 12 using a heat transfer method. This process is well known and will not be described in detail herein. Briefly, the label 10 is prepared in advance on a transfer sheet. The fabric material 12 and the transfer sheet are brought into physical contact and heat of a sufficient temperature is applied to the transfer sheet and the fabric material 12 to cause the label 10 to transfer onto the fabric material 12 and be permanently imprinted or bonded thereto.

It is to be understood that other methods and processes of applying the label 10 can be used, such as printing, screen printing, and embroidery, as well as other known methods of forming or transferring indicia on to fabric or textile material. The present disclosure of the dashboard design can be incorporated into a larger graphic design. In addition, the present disclosure can be utilized with other substrates or base material, such as paper, other consumable textiles, and even in electronic form, such as on a screen display, which can be implemented using known methods for software, firmware, and hardware and can be implemented in all visual formats.

The label 10 includes a base 14 formed of heat transferrable material. The base material 14 may be of a material tape or of vinyl as is known in the industry. The base 14 has indicia 16 thereon that divide the label 10 into four sections, as shown in FIG. 1. Alternatively, the label 10 can be formed of four distinct sections without the dividing indicia 16 wherein the sections are divided by strips 18 of the fabric material 12 as shown in FIG. 2.

As shown in FIGS. 1 and 2, the four sections include, from left to right, a size section 20, a message section 22, a barcode section 24, which in this case is a matrix barcode or more preferably a QR code, and a care section 26. It is to be understood that the order and arrangement of the sections 20, 22, 24, 26 can be varied as can the number of sections used in the label 10. For example, the sections 20, 22, 24, 26 can be arranged horizontally as shown or vertically, diagonally, or as four sections of a larger square or rectangle. In addition, the square shape of each of the sections can be any geometric shape, including rectangle, triangle, circle, trapezoid, and rhombus, to name a few.

Ideally, there are four sections, although three sections can be used or at minimum the size and care sections 20, 26 can be consolidated and positioned as one section next to the barcode section 24 to form a two-section label.

In the preferred embodiments shown in FIGS. 1 and 2, a “dashboard” form of presentation in a horizontal orientation is used for the label 10. The first section 20 is the size section which displays the size of the garment to which the label 10 is applied, in this case the medium size is shown with the capital letter “M” as is the convention in the garment industry. Other information may be included in the size section, such as the size in inches or international sizes corresponding to the “medium” size.

The second section 22 is the message section that conveys a social message or other textual or graphic image that is selected by the manufacturer, the retailer or the user of the product. For example, a personalized message could include the purchaser's name, address or other identifying indicia.

The barcode section 24 utilizes the conventional matrix barcode, known in one form as a Quick Read or “QR code.” Inasmuch as these codes are well know, they will not be described in detail herein. Encoded in the QR code can be information about the product to which the label 10 is applied, such as the style name, date of manufacture, manufacturer identification, and further information about the type of fabric. However, in a preferred embodiment, the QR code includes a uniform resource identifier (URI) that identifies a name or a web resource. Generally, such identifiers can take the form of a uniform resource locator (URL) or uniform resource name (URN). Another example would be the use of an ISBN number for identifying a book or periodical to which the label could be applied or which pertains to the product on which the label is applied. Preferably, a URL is used that can be scanned by a reader, such as a mobile phone using a QR reader app, which takes the user directly to a website to enable reordering of the product.

A Matrixed Barcode in the form of a Quick Response (not Quick Read) code can be used as well. These codes were designed to store much more information than is possible than a standard binary barcode. Hence, an inventory tracking system will be QR friendly and this one form of imaged data can be used to manage all forms of inventory.

Finally, the care section 26 includes information about the type of construction of the product, in this case the type of material used to make up the fabric, as well as care instructions for washing and cleaning the garment.

Also included as part of the label is a tagline 28 positioned above the sections 20, 22, 24, 26. In this case, the tagline consists of four two-word phrases: “SIZE UP” positioned above the size section 20, “RISE UP” positioned above the message section 22, “STOCK UP” positioned above the barcode section 24, and “CLEAN UP” positioned above the care section 26. The tagline 28 functions not only as a brand identifier, it also indicates the content of the various sections. Finally, included with the label 10 is a web address line 30 positioned below the sections to provide a visual address for locating the company that markets the product. Both the tagline 28 and the web address 30 are optional features of the label 10, and it is to be understood that their positions may be reversed, i.e., the web address positioned above the sections and the tagline positioned below the sections.

Turning next to FIG. 2, shown therein is a labeling system formed in accordance with the present disclosure to include the label 10 on the fabric product 12, a worldwide computer network, in this case identified as the Internet 32, and a computing system 34 that is in communication with the Internet 32. Because the Internet is well known, it will not be described in detail herein. Communication via the Internet is also well known and is exploited in the present disclosure to facilitate communication between consumers of the product and the provider of the product, in this case the owner of the computing system 34. Such computing systems 34 are well known and also will not be described in detail herein. Briefly, the computing system includes a means for electronic communication to and from the Internet, such as a modem. This may be directly wired to the Internet or wireless communication may be used as well. The computing system also includes a central processor coupled to a database for storing information about the product 12, among other things, such as consumer information obtained from the purchaser of the product 12, either at the time of purchase or during reorder, as described in more detail below. Preferably the computing system is automated to facilitate reordering of the fabric product 12 as will be described in more detail herein. The system does not include warehouses for storing products, manufacturing facilities for manufacturing products, or delivery services for packaging and delivering products to the consumer.

Referring next to FIG. 3, illustrated therein is the system in use. A consumer's' cell phone or other mobile device, identified in this case as a reader 36, is used to scan the QR code in the barcode section 24 to retrieve and upload the web address for the computing system 34. Via well-known communication means, which includes a cell tower 38, the reader 36, which can be the user's cell phone, communicates via the cell tower 38 and the Internet 32 to the computing system 34, which displays the web page on the user's device or reader 36. The displayed web page can then be used by the user to reorder the fabric product 12 or to order other products or to contact the retailer, distributor, or manufacturer as enabled by the system. During the reorder process, users can specify the type of product they wish to order as well as select or create a personalized message for the message section 22.

Optional features to the system include the ability to track usage of the QR code by consumers or by the identified product. This allows the owner or manufacturer or retailer who uses the system to better understand consumer behavior as well as improve product quality and communication with consumers through the ordering process.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A fabric label, comprising:
a base material applied to the fabric; and
a labeling area on the base material organized into at least three sections that comprise:
a size section having indicia indicating a size of the fabric material;
a matrix barcode section configured to store data related to at least one from among the fabric, reorder information, and a URI; and
a care instruction section.

2. The label of claim 1, wherein the base material is configured to be applied to the fabric using a heat transfer method.

3. The label of claim 1, wherein the label further includes a message section.

4. The label of claim 3, wherein the message section includes indicia related to personalized content.

5. The label of claim 1, further including a tag line in the labeling area.

6. The label of claim 5, further including at least one web address in the labeling area that is in human readable form.

7. The label of claim 1, wherein the labeling area comprises a dashboard arrangement of the size section, matrix barcode section, and care section.

8. The label of claim 7, wherein the dashboard arrangement comprises one from among a horizontal or vertical arrangement of the sections or a combination of a vertical and a horizontal arrangement of the sections.

9. A system, comprising:
a product;
a tagless label applied to the product, the label comprising a labeling area organized into at least three sections that comprise:
a size section having indicia indicating a size of the fabric material;
a matrix barcode section configured to store data related to at least one from among the fabric, reorder information, and a URI; and
a care instruction section;
a remote computing system configured to be accessible via a worldwide network of computers using the URI in the matrix barcode section of the label, the remote computing system configured to enable at least one from among ordering of the product, information about the product, and information about the provider of the product; and
a reader configured to read the matrix barcode in the matrix barcode section and to communicate with the remote computing system via the worldwide network of computers.

10. The system of claim 9, wherein the base material is configured to be applied to the fabric using a heat transfer method.

11. The system of claim 9, wherein the label further includes a message section.

12. The system of claim 11, wherein the message section includes indicia related to personalized content.

13. The system of claim 9, further including a tag line in the labeling area.

14. The system of claim 13, further including at least one web address in the labeling area that is in human readable form.

15. The system of claim 9, wherein the labeling area comprises a dashboard arrangement of the size section, matrix barcode section, and care section.

16. The system of claim 15, wherein the dashboard arrangement comprises one from among a horizontal or vertical arrangement of the sections.
